(19) United States
(12) Patent Application Publication
(10) Pub. No.: US 2024/0388446 A1
(43) Pub. Date: Nov. 21, 2024

(54) DETERMINISTIC ENFORCEMENT OF DIGITAL CERTIFICATE AMENDMENTS

(71) Applicant: Dell Products L.P., Round Rock, TX (US)

(72) Inventor: Bradley K. Goodman, Nashua, NH (US)

(21) Appl. No.: 18/318,976

(22) Filed: May 17, 2023

(51) Int. Cl. H04L 9/32

(52) U.S. Cl. CPC H04L 9/3263; H04L 9/3242

(57) ABSTRACT

An apparatus comprises at least one processing device configured to receive a hash value for a digital certificate and an amendment for a portion of the digital certificate, and to determine whether the hash value corresponds to a last version of the digital certificate on the at least one processing device. The at least one processing device is further configured to incorporate the amendment into a new version of the digital certificate in response to determining that the hash value corresponds to the last version of the digital certificate on the at least one processing device.

### FIELD

The field relates generally to information processing, and more particularly to digital certificate management in information processing systems.

### BACKGROUND

Computing devices may utilize digital certificates (e.g., cryptographic certificates) for various security operations. Digital certificates may include user and/or device authorizations to perform the various operations and are typically issued with an expiration date for security purposes. In some instances, prior to expiration of a digital certificate, one or more authorizations or other particulars specified in the digital certificate may no longer be applicable. Accordingly, management of digital certificates is required to account for changes that may occur while the digital certificates are active.

### SUMMARY

Illustrative embodiments of the present disclosure provide techniques for managing digital certificates in endpoint devices.

In one embodiment, an apparatus comprises at least one processing device comprising a processor coupled to a memory. The at least one processing device is configured to perform the steps of receiving a hash value for a digital certificate and an amendment for a portion of the digital certificate, and determining whether the hash value corresponds to a last version of the digital certificate on the at least one processing device. The at least one processing device is further configured to perform the step of incorporating the amendment into a new version of the digital certificate in response to determining that the hash value corresponds to the last version of the digital certificate on the at least one processing device.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for managing digital certificates in endpoint devices in an illustrative embodiment.

FIG. 2 shows a process flow for amending a digital certificate in an illustrative embodiment.

FIG. 3 is a flow diagram of an exemplary process for managing digital certificates in endpoint devices in an illustrative embodiment.

FIGS. 4 and 5 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

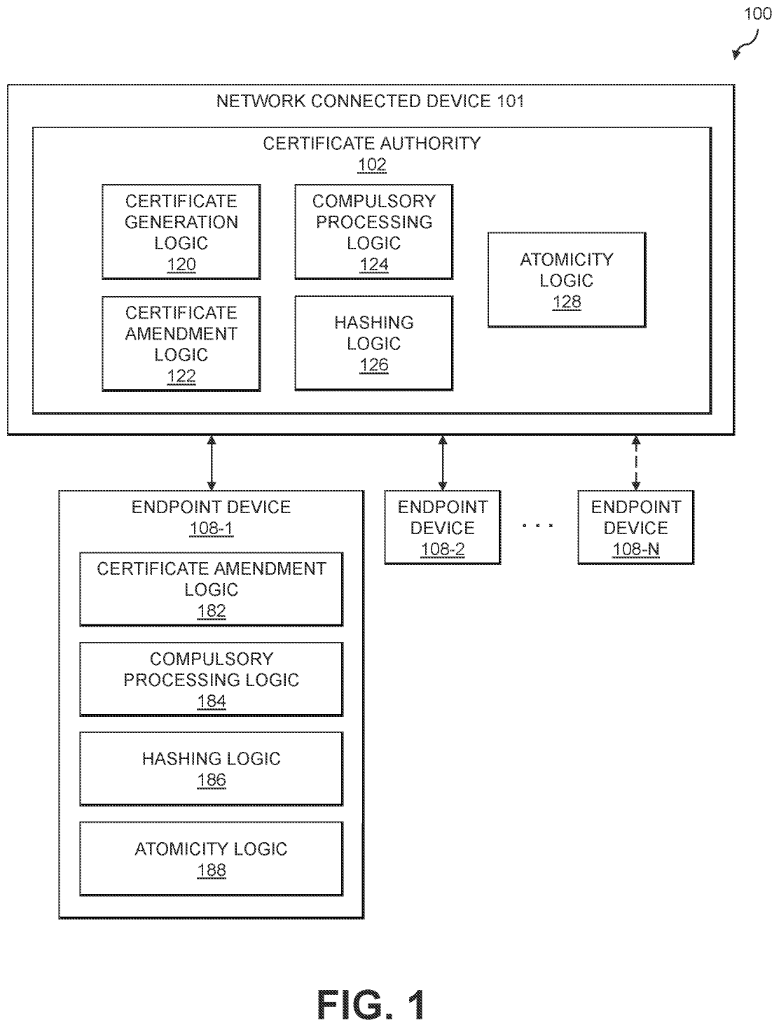

FIG. 1 shows an information processing system 100 configured in accordance with an illustrative embodiment. The information processing system 100 is assumed to be built on at least one processing platform and provides functionality for management of digital certificates in endpoint devices. The system 100 includes at least one network connected device 101 including a certificate authority 102, and a plurality of endpoint devices 108-1, 108-2, . . . 108-N (collectively, endpoint devices 108). As shown by the solid arrows, at least some of the endpoint devices 108 (e.g., endpoint devices 108-1 and 108-2) are connected to the network connected device 101 and, as shown by the solid arrows, one or more of the endpoint devices 108 (e.g., endpoint device 108-N) are not connected to the network connected device 101 or are intermittently connected to the network connected device 101.

As used herein, the terms “certificate,” “digital certificate” or “cryptographic certificate” are intended to be broadly construed, so as to encompass, for example, a data file that includes information for verifying the identity of a device (e.g., server, endpoint device, edge device, etc.) and/or a user. The information includes, for example, a public key, an identification of the issuing authority of the certificate (e.g., certificate authority 102), and an expiration date of the certificate. For example, in establishing trust between devices, encryption protocols such as, but not necessarily limited to, transport layer security (TLS) protocol, authenticate a server in a client-server connection and encrypt communications between the client and server. Some encryption protocols, like TLS, employ public key cryptography, utilizing a pair of keys (a public key and a private key). Data encrypted with the public key can be decrypted only with the private key. For example, a device that decrypts a message that was encrypted with a public key verifies that the device possesses the private key. The public key is available through the certificate of a domain or device.

In illustrative embodiments, a certificate conveys more than trust between devices and includes information granting multiple permissions to multiple users across multiple resources. In such situations, where a certificate defines a larger set of capabilities, there is a need to revoke, change, modify, add or otherwise amend a relatively small portion of the certificate or specific subset of the capabilities. In a non-limiting operational example, a certificate may grant permission to users B, C and D to perform an operation, and at a later time, a determination is made to revoke only user D′s permission.

With conventional approaches, a certificate is revoked in its entirety. However, revocation of the entire certificate would also invalidate the permissions of user B and C, which is not intended. In order to restore permissions to user B and C, current approaches require a follow-on operation which generates a new certificate granting the permissions to user B and C. The generation of the new certificate creates additional possible complexities such as, but not necessarily limited to, the need to amend prior statements of work with new permissions, as the old statements would be invalided, especially if the work statements are “long-lived.” As used herein, “long-lived” refers to requests to endpoint devices 108 that are valid over a long period of time. For example, instead of a single imperative request (e.g., “run this job”), a long-lived statement declares, for example, that a job should be continuously running, with a need to evaluate and re-evaluate the parameters of the job over the entire lifespan of a job, which could be indefinite.

Mechanisms such as, for example, a certificate revocation list (CRL) and the online certificate status protocol (OCSP) allow certificates to be created and subsequently revoked. A CRL is a list of revoked public key certificates. A CRL can be created and digitally signed by a certificate authority. Certificate authorities periodically issue CRLs, which users can retrieve via one or more repositories. OCSP is an alternative to a CRL and is used to check whether a digital certificate is valid or if it has been revoked. OCSP is an Internet Protocol (IP) certificate authorities use to determine certificate status (e.g., the status of secure sockets layer (SSL) or TLS certificates).

In an effort to address the problems associated with conventional approaches, the illustrative embodiments provide technical solutions to enable specific changes or amendments to portions of prior (e.g., issued) certificates, without revoking an entire certificate. In addition, illustrative embodiments provide techniques to specify and enforce rules that ensure that certificate amendments are applied, even when endpoint devices 108 are not connected to the Internet.

Referring back to FIG. 1, the certificate authority 102 implements various software components or logic, including certificate generation logic 120, certificate amendment logic 122, compulsory processing logic 124, hashing logic 126 and atomicity logic 128. Similarly, the endpoint device 180-1 implements various software components or logic, including certificate amendment logic 182, compulsory processing logic 184, hashing logic 186 and atomicity logic 188. Although not shown in FIG. 1, other ones of the endpoint devices 108-2 through 108-N are assumed to similarly implement respective instances of certificate amendment logic 182, compulsory processing logic 184, hashing logic 186 and atomicity logic 188.

In some embodiments, the network connected device 101 and endpoint devices 108 are used for an enterprise system. For example, an enterprise may use certificate authority 102 to manage the set of endpoint devices 108. As used herein, the term “enterprise system” is intended to be construed broadly to include any group of systems or other computing devices. For example, the network connected device 101 and endpoint devices 108 may provide all or a portion of one or more enterprise systems. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The network connected device 101 and the endpoint devices 108 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The processing devices may also or alternately comprise virtualized computing resources, such as virtual machines (VMs), containers, etc.

The network connected device 101 and the endpoint devices 108 in some embodiments comprise respective computers associated with a particular company, organization or other enterprise. Thus, the network connected device 101 and the endpoint devices 108 may be considered examples of assets of an enterprise system. In addition, at least portions of the system 100 may also be referred to herein as collectively comprising one or more “enterprises.” Numerous other operating scenarios involving a wide variety of different types and arrangements of processing nodes are possible, as will be appreciated by those skilled in the art.

Networks coupling the network connected device 101 and one or more of the endpoint devices 108 are assumed to comprise a global computer network such as the Internet, although other types of networks can be used, including a wide area network (WAN), a local area network (LAN), a satellite network, a telephone or cable network, a cellular network, a wireless network such as a WiFi or WiMAX network, or various portions or combinations of these and other types of networks.

Although not explicitly shown in FIG. 1, one or more input-output devices such as keyboards, displays or other types of input-output devices may be used to support one or more user interfaces to the network connected device 101 and the endpoint devices 108, as well as to support communication between the network connected device 101, the endpoint devices 108 and other related systems and devices not explicitly shown.

In some embodiments, the network connected device 101 is assumed to be associated with a system administrator, IT manager or other authorized personnel responsible for managing the endpoint devices 108 (e.g., where such management includes managing certificates and authorizations associated with the endpoint devices 108). In some embodiments, the endpoint devices 108 are owned or operated by the same enterprise that operates the network connected device 101. In other embodiments, the endpoint devices 108 may be owned or operated by one or more enterprises different than the enterprise which operates the network connected device 101.

The network connected device 101 and the endpoint devices 108 in the FIG. 1 embodiment are assumed to be implemented using at least one processing device. Each such processing device generally comprises at least one processor and an associated memory, and implements one or more functional modules or logic for controlling certain features of the network connected device 101 and the endpoint devices 108 (e.g., certificate generation logic 120, certificate amendment logic 122/182, compulsory processing logic 124/184, hashing logic 126/186 and atomicity logic 128/188).

It is to be appreciated that the particular arrangement of the network connected device 101 and the endpoint devices 108 illustrated in the FIG. 1 embodiment is presented by way of example only, and alternative arrangements can be used in other embodiments. For example, one or more of the endpoint devices 108 may in some embodiments be connected to the network connected device 101, not connected to the Internet or other network, or may be intermittently connected to the Internet or other network. As another example, the functionality associated with the certificate generation logic 120, certificate amendment logic 122/182, compulsory processing logic 124/184, hashing logic 126/186 and atomicity logic 128/188 may be combined, or separated across more modules or logic with the multiple modules or logic possibly being implemented with multiple distinct processors or processing devices.

At least portions of the certificate generation logic 120, certificate amendment logic 122/182, compulsory processing logic 124/184, hashing logic 126/186 and atomicity logic 128/188 may be implemented at least in part in the form of software that is stored in memory and executed by a processor. Various portions of the system 100, such as the network connected device 101, as will be described in further detail below, may be part of cloud infrastructure.

The network connected device 101, the endpoint devices 108 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The network connected device 101 and the endpoint devices 108 or components thereof (e.g., the certificate generation logic 120, certificate amendment logic 122/182, compulsory processing logic 124/184, hashing logic 126/186 and atomicity logic 128/188) may be implemented on respective distinct processing platforms, although numerous other arrangements are possible.

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for portions or components of the network connected device 101 to reside in different data centers. Numerous other distributed implementations are possible. The network connected device 101 and the endpoint devices 108 can also be implemented in a distributed manner across multiple data centers.

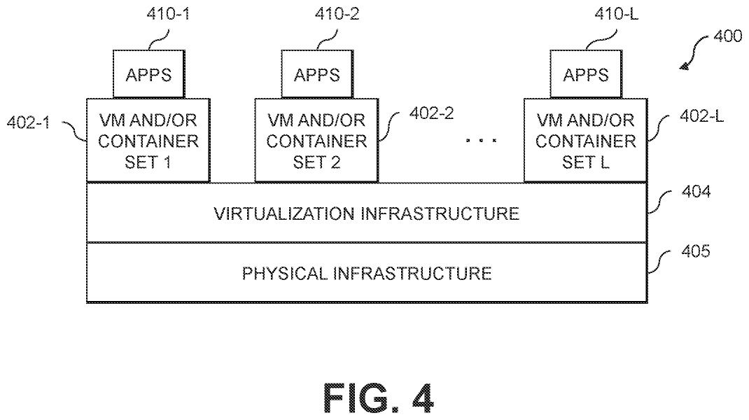

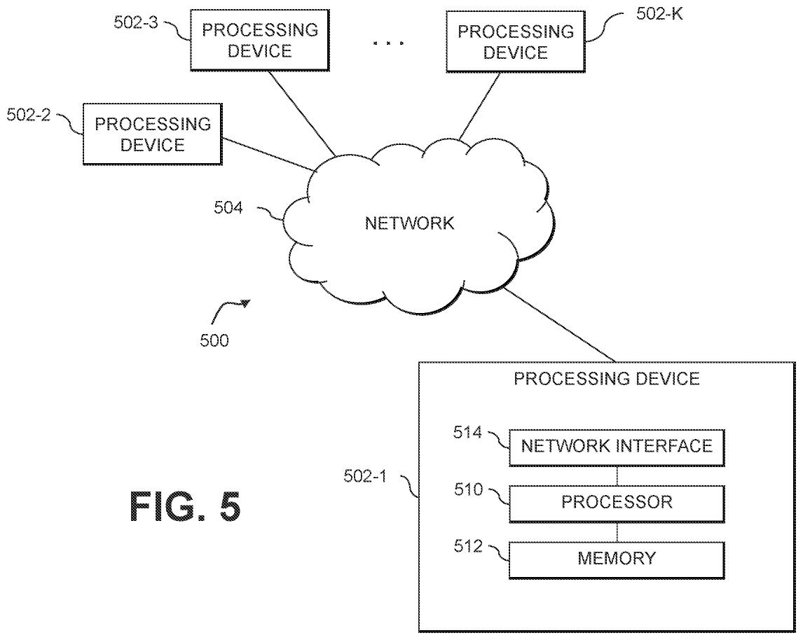

Additional examples of processing platforms utilized to implement the network connected device 101, the endpoint devices 108 and other components of the system 100 in illustrative embodiments will be described in more detail below in conjunction with FIGS. 4 and 5.

It is to be appreciated that these and other features of illustrative embodiments are presented by way of example only, and should not be construed as limiting in any way.

It is to be understood that the particular set of elements shown in FIG. 1 for managing digital certificates in endpoint devices is presented by way of illustrative example only, and in other embodiments additional or alternative elements may be used. Thus, another embodiment may include additional or alternative systems, devices and other network entities, as well as different arrangements of modules and other components.

Referring to back to FIG. 1, the certificate generation logic 120 of the certificate authority 102 generates a digital certificate which is sent to one or more of the endpoint devices 108. As explained herein above, the certificate can be used to authenticate the network connected device 101 in a connection between an endpoint device 108 and the network connected device 101, and can be used to encrypt communications between the endpoint device 108 and the network connected device 101. In addition, the certificate may include information granting multiple permissions to multiple users across multiple resources. In a non-limiting operational example, a certificate generated by the certificate authority 102 may specify the following:
Certificate: Cert_ID=1234
Permit: User=A Allow= [All_Operations]
Permit: User=B Allow= [Start_Jobs, Stop_jobs]
Permit: User-C Allow= [Show_jobs]

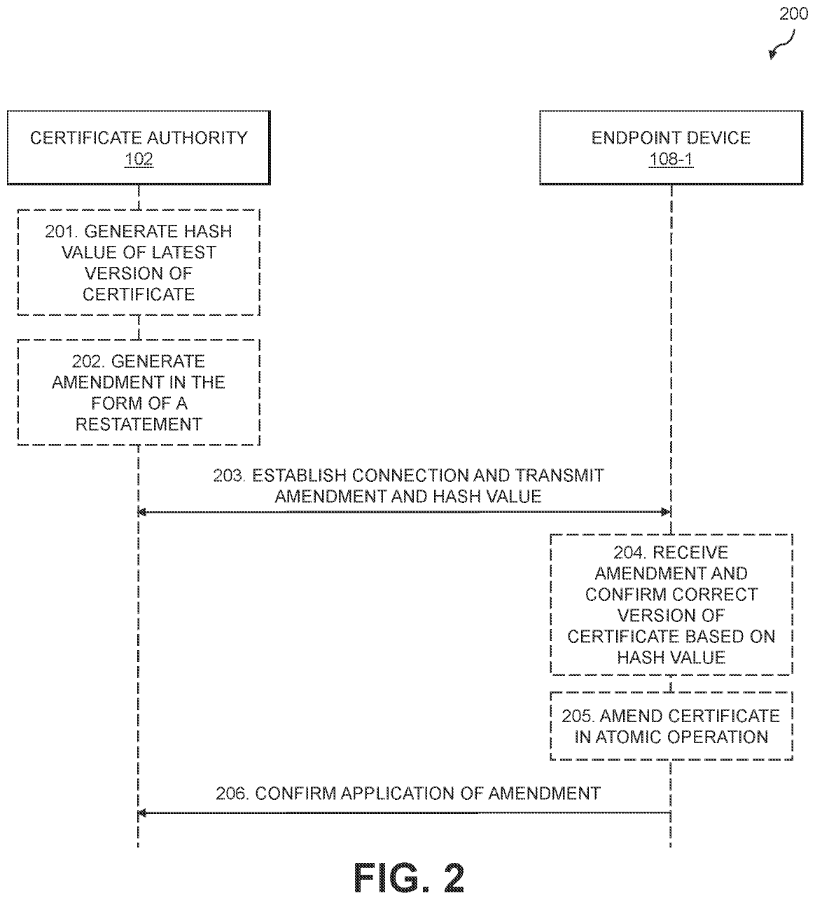

In this case, the certificate, which is identified by a certificate identifier (Cert_ID) of 1234, provides designated permissions for user A (all operations), user B (start jobs, stop jobs) and user C (show jobs). Given a particular situation, it may be necessary to amend one or more portions of the certificate. For example, one or more statements in an issued certificate that is being used by one or more endpoint devices 108 may need to be revoked or amended. In this case, referring to the process flow 200 in FIG. 2, at step 201, the hashing logic 126 generates a hash value of the last (e.g., latest) version of the certificate according to the certificate authority 102. As used herein, the term “hash value” is intended to be broadly construed, so as to encompass, for example, a fixed-size numeric or alphanumeric string (also called a message digest, a digital fingerprint, a digest, or a checksum) obtained by applying a hash function to data. Hash values typically represent large amounts of data as much smaller strings. A hash value can be generated using, for example, a cryptographic hash function such as, but not necessarily limited to, md5sum, sha256 or other hashing algorithm. A cryptographic hash function is a cryptographic function which takes an input (or “message”) (e.g., latest certificate version) and returns the fixed-size numeric or alphanumeric string (i.e., the hash value). In some cases, like a blockchain, the hash value may be accompanied by a timestamp and information linking it to a previous version of the certificate (if there is a previous version of the certificate). Each resulting hash value is unique such that if one item of data in the certificate is altered, the hash value changes. As explained in more detail herein, computation of the hash value is used to ensure that the correct version of the certificate is being amended. For example, in some cases, multiple certificate amendments may be received by an endpoint device 108 at different times and/or from different sources. In this case, depending on the nature of the amendments, confirming what version of the certificate an amendment pertains to can affect whether the amendment is properly applied.

At step 202, the certificate amendment logic 122 generates an amendment for a certificate. The amendment may be in the form of a restatement pertaining to a portion of the certificate. A restatement may be a full restatement or a partial restatement. As used herein, a “full restatement” refers to the issuance of new certificate contents for a portion of a certificate which fully replaces the contents of the portion of the previous version of the certificate. In some embodiments, in the case of a full restatement, a new certificate is generated incorporating the new content that replaces the portion of the previous version of the certificate that is being amended. In other aspects, the new version of the certificate is the same as the previous version of the certificate. In keeping with the operational example, the original certificate generated by the certificate authority 102 specifies the following:
Certificate: Cert_ID=1234
Permit: User=A Allow= [All_Operations]
Permit: User=B Allow= [Start_Jobs, Stop_jobs]
Permit: User=C Allow= [Show_jobs]

An example of a full restatement is as follows:
Amendment: Cert ID=1234
User=A Allow= [All_Operations]
User=C Allow= [Show_jobs]

This amendment removes user B. Therefore, a recipient device that receives this amendment would determine that user B no longer has authorization to start or stop jobs, but that user A and user C retain their permissions. Referring to back to the need for a hash value, assuming that an endpoint device 108 receives the above amendment and then receives a subsequent (second) amendment specifying the following:
Amendment: Cert ID=1234
User=A Allow= [All_Operations]
Permit: User-B Allow= [Start_Jobs, Stop_jobs]

This statement states that user B has permissions to start or stop jobs, but user C no longer has authorization to show jobs. If this second amendment is received after the first amendment, the second amendment restores user B′s permissions and removes user C′s permissions. However, if a hash value confirmation process is not in place, and the second amendment is received before the first amendment, initially, user C′s permissions are removed, then upon receipt of the first amendment (after the second amendment), user C′s permissions are restored and user B′s permissions are removed.

The problem lies in the ordering. As can be understood, if the second amendment were received prior to the first, the end-result is completely different than if the amendments are received in the correct order. As a result, ordering enforcement is needed. In the illustrative embodiments, a hash value of the certificate on which the amendment is being made is computed and specified with the amendment.

Referring to step 203, a connection with the endpoint device 108-1 is established (e.g., between the network connected device 101 and the endpoint device 108-1) and the amendment is transmitted to the endpoint device 108-1 along with the computed hash value. At step 204, the certificate amendment logic 182 of the endpoint device 108-1 receives the amendment and the hash value. The hashing logic 186 computes the hash value of a last version of the certificate on the endpoint device 108-1, compares the computed hash value to the hash value received with the amendment and determines whether the received hash value is the same as the hash value of the last version of the digital certificate on the endpoint device 108-1. If the hash value is the same, this confirms that the correct version of the certificate is being amended, and the certificate amendment logic 182 and atomicity logic 188 apply the amendment. Referring to step 205, the certificate amendment logic 182 along with the atomicity logic 188 apply the amendment in an atomic operation, where the amendment is incorporated into a new version of the digital certificate while simultaneously removing the previous unamended version. The certificate amendment logic 182 and atomicity logic 188 restate or replace the portion of the certificate to be amended with the amended portion, which removes the unamended portion so that there is effectively no time or condition between certificate versions. Once an amendment has been applied, in step 206, the compulsory processing logic 184 transmits a message to the certificate authority 102 that the amendment has been applied to the certificate in the endpoint device 108-1. As noted herein above, in some embodiments, in the case of a full restatement, a new certificate is generated incorporating the new content that replaces the portion of the previous version of the certificate that is being amended. As explained, the generation of the new certificate may be performed by the atomicity logic 188 at the endpoint device 108-1 upon application of the amendment. Alternatively, the generation of the new certificate may be performed by the atomicity logic 128 of the certificate authority 102 and the new certificate can be transmitted along with the amendment and hash value to one or more of the endpoint devices 108.

If the computed hash value is not the same, this confirms that the version of the certificate for which the amendment was generated does not match the version of the certificate on the endpoint device 108-1. This can be due to, for example, an amendment that was previously applied on the endpoint device 108-1 from another issuing authority (e.g., another certificate authority) with authorization to amend the certificate and/or an amendment that is being received out of order from the certificate authority 102. The amendment may be received out of order due to, for example, a problem with the transmission of a prior amendment. In the case that the hash values are different, the compulsory processing logic 184 transmits a message to the certificate authority 102 (e.g., an error message) indicating the hash values are different and that the amendment has not been applied. If there are two independent entities, unaware of each other, that attempt to amend a current (or original) certificate, the first amendment to reach the endpoint device 108-1 would succeed due to having the correct hash value and the second amendment to reach the endpoint device 108-1 would fail, because the second amendment would have specified an incorrect hash value of the previous or original certificate and not that of the certificate following the first amendment.

As noted above, the amendment may be in the form of a restatement pertaining to a portion of the certificate, and the restatement may be a full restatement or a partial restatement. As used herein, a “partial restatement” refers to a statement that identifies the change being made without restating other permissions in the portion of the certificate being amended. In keeping with the operational example, the original certificate generated by the certificate authority 102 specifies the following:
Certificate: Cert_ID=1234
Permit: ID=1 User=A Allow= [All_Operations]
Permit: ID=2 User=B Allow= [Start_Jobs, Stop_jobs]
Permit: ID=3 User=C Allow= [Show_jobs]

An example of a partial restatement is as follows:
Amendment: Cert ID=1234
Revoke: ID=2

This amendment removes user B. Therefore, a recipient device that receives this amendment would determine that user B no longer has authorization to start or stop jobs, but that user A and user C retain their permissions. A subsequent (second) amendment in the form of a partial restatement received by the endpoint device 108-1 may specify the following:
Amendment: Cert_ID=1234
Revoke: ID=3

This statement states that user C no longer has authorization to show jobs. Therefore, a recipient device that receives this second amendment after the first amendment would determine that user B and user C no longer have their authorizations, and only user A retains their permission. In this case, even if the first and second amendments in the partial restatement format are provided in a different order, the net conclusion would be the same. This is because these particular amendments are limited to revocations. In the case of only revocations of permissions, hash value analysis may be omitted if partial restatements are used to convey the amendments.

However, if the first and second amendments are not limited to revocations, order would again be a factor, such that hash values would be necessary. For example, the following partial restatement amendments specify:
Amendment: Cert_ID=1234
Change: ID=2 User=B Allow= [All_Operations]
   and
Amendment: Cert_ID=1234
Change: ID=2 User-B Allow= [Start_jobs]

Note that how an endpoint device 108 would interpret user B′s ultimate permissions would depend on the ordering in which these two messages were received. In this case, requiring confirmation of last certificate version hash values would allow for confirmation that the amendments were received in a proper order.

A full restatement is more easily parsed than a partial restatement. Partial restatements are schema and format specific, and may require more complex and schema-specific parsing logic than full restatements. Partial restatements result in terser amendments than full restatements, since only single statements are rewritten or revoked. As noted herein above, partial restatement revocations can be issued by independent sources without conflict or consideration of receipt order.

When a certificate amendment is generated by, for example, the certificate authority 102, and transmitted, the application of the amendment is predicated on the ability of the endpoint device 108 to receive and apply the amendment. If an endpoint device 108 is connected to the Internet, receipt of an amendment is facilitated. However, there may be network or other issues which prevent transmission and/or receipt of the amendment. If an endpoint device 108 is not connected to the Internet, such as in the case of an endpoint device 108 that is executing operations offline due to, for example, security reasons, receipt of the amendment is prevented. In either case, the illustrative embodiments provide enforcement mechanisms to ensure that certificate amendments are applied when issued.

The ability to obstruct or ignore requirements or operations for applying certificate amendments could place security at-risk. For example, absent the enforcement mechanisms of the illustrative embodiments, there may be situations where a certificate is amended but the amendment is not applied because an endpoint device never polled for the amendment or was nefariously blocked from doing so. CRLs and OCSP may provide locations where endpoint devices could check for amendments, but OCSP explicitly is predicated on connectivity to servers to check certificate status, and both CRLs and OCSP place the onus on the endpoint devices 108 to check certificate status. Specifying a CRL in which the expectation is that the endpoint device 108 will make best efforts to check and enforce certificate amendments is insufficient, especially when the endpoint device normally operates offline.

In illustrative embodiments, the compulsory processing logic 124 and 184 is used to establish and enforce rules designed to ensure application of any issued amendments to a digital certificate. The compulsory processing logic 124 and 184 is configured to provide an interface for users to input one or more rules for enforcement of amendment application. The rules may specify, for example, a maximum time interval within which an endpoint device 108 is to perform a check to determine whether any amendments to a last version of a digital certificate have been issued, and one or more operations to be performed by the endpoint device 108 in response to a failure to perform the check within the maximum time interval. The one or more operations comprise, for example, generating a warning message indicating the failure to perform the check within the maximum time interval, preventing future operations authorized by the last version of the digital certificate following expiration of the maximum time interval, and terminating existing operations authorized by the last version of the digital certificate following expiration of the maximum time interval.

For example, upon expiration of a time interval (e.g., 1 week, 1 month, etc.) within which an endpoint device 108 is to perform a check to determine whether any amendments to a last version of a digital certificate have been issued, the compulsory processing logic 184 of an endpoint device 108 may generate a warning message indicating the failure to perform the check within the maximum time interval. The warning message can be displayed on the endpoint device 108 and/or sent to another device if the endpoint device is connected to a network. Upon expiration of the time interval, the compulsory processing logic 184 of the endpoint device 108 may prevent future operations authorized by the last version of the digital certificate and/or terminate existing operations authorized by the last version of the digital certificate. The compulsory processing logic 124 of the certificate authority 102 receives notifications from endpoint devices 108 regarding whether amendments have been applied, whether amendment have not been applied and/or whether endpoint devices 108 have not performed required checks for amendments. As discussed herein, in some cases the amendments may not be applied due to hash values that do not match. The compulsory processing logic 184 of the endpoint devices 108 may send notifications to the certificate authority 102 that amendments have been applied, that amendment have not been applied and/or that endpoint devices 108 have performed required checks for amendments.

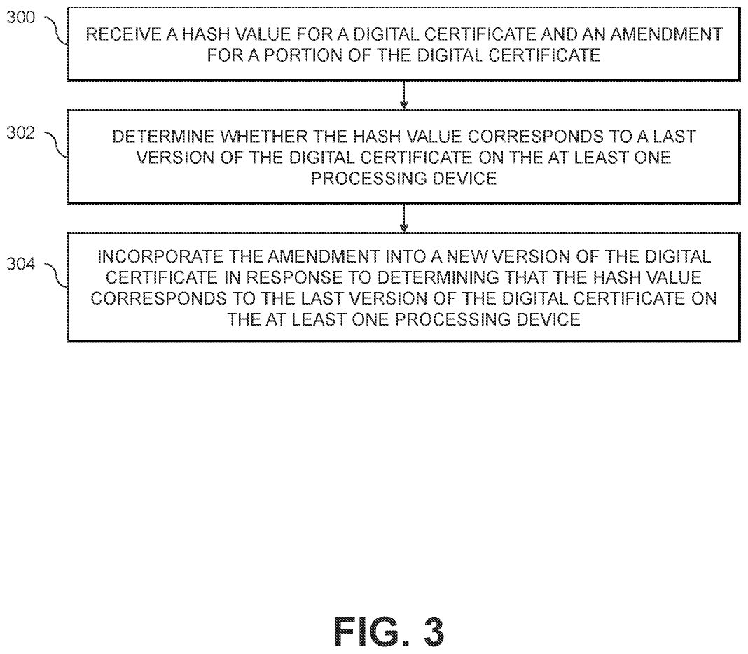

An exemplary process for managing digital certificates in endpoint devices will now be described in more detail with reference to the flow diagram of FIG. 3. It is to be understood that this particular process is only an example, and that additional or alternative processes for managing digital certificates in endpoint devices may be used in other embodiments.

In this embodiment, the process includes steps 300 through 304. These steps are assumed to be performed by one or more of the endpoint devices 108 utilizing the certificate amendment logic 182, the compulsory processing logic 184, the hashing logic 186 and the atomicity logic 188. The process begins with step 300, receiving a hash value for a digital certificate and an amendment for a portion of the digital certificate. In some embodiments, the amendment comprises a restatement associated with the portion of the digital certificate. The restatement can be a full restatement or a partial restatement, and can comprise a revocation of the portion of the digital certificate. In illustrative embodiments, the amendment specifies an identifier for the digital certificate and one or more changes to the portion of the digital certificate.

In step 302, a determination is made whether the hash value corresponds to a last version of the digital certificate on at least one processing device (e.g., an endpoint device 108). At step 304, in response to determining that the hash value corresponds to the last version of the digital certificate, the amendment is incorporated into a new version of the digital certificate. In response to determining that the hash value fails to correspond to the last version of the digital certificate on the at least one processing device, a notification for a source of the amendment that the hash value fails to correspond to the last version of the digital certificate is generated, and the last version of the digital certificate is maintained on the at least one processing device (e.g., endpoint device 108) without incorporating the amendment. The notification may also include an indication that the amendment has not been applied.

In illustrative embodiments, one or more rules designed to ensure application of any issued amendments to the last version of the digital certificate are applied. The one or more rules specify, for example, a maximum time interval within which to perform a check to determine whether any amendments to the last version of the digital certificate have been issued and one or more operations to be performed by the at least one processing device in response to a failure to perform the check within the maximum time interval. The at least one processing device executes the one or more operations in response to the failure to perform the check within the maximum time interval. In illustrative embodiments, the one or more operations comprise, but are not necessarily limited to, generating a warning message indicating the failure to perform the check within the maximum time interval, preventing future operations authorized by the last version of the digital certificate following expiration of the maximum time interval, and/or terminating existing operations authorized by the last version of the digital certificate following expiration of the maximum time interval.

In incorporating the amendment into the new version of the digital certificate, the last version of the digital certificate is replaced with the new version of the digital certificate. In some embodiments, the incorporating and the replacing are performed by the at least one processing device in the same operation.

Illustrative embodiments provide technical solutions for amending cryptographic certificates and ensuring that the amendments are applied. Advantageously, the embodiments provide for enforcement mechanisms to ensure that amendments are applied even when endpoint devices are offline or there are issues with connectivity. As an additional advantage, the embodiments provide techniques which use hash values to ensure that the correct versions of certificates are being amended. In some embodiments, the amendments are applied in an atomic operation such that in the same operation, the amendments are incorporated into a new certificate version and the new certificate version is issued. Amendments in the form of restatements allow for conflict-free revocation of specific portions of a certificate.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for managing digital certificates in endpoint devices will now be described in greater detail with reference to FIGS. 4 and 5. Although described in the context of system 100, these platforms may also be used to implement at least portions of other information processing systems in other embodiments.

FIG. 4 shows an example processing platform comprising cloud infrastructure 400. The cloud infrastructure 400 comprises a combination of physical and virtual processing resources that may be utilized to implement at least a portion of the information processing system 100 in FIG. 1. The cloud infrastructure 400 comprises multiple virtual machines (VMs) and/or container sets 402-1, 402-2, . . . 402-L implemented using virtualization infrastructure 404. The virtualization infrastructure 404 runs on physical infrastructure 405, and illustratively comprises one or more hypervisors and/or operating system level virtualization infrastructure. The operating system level virtualization infrastructure illustratively comprises kernel control groups of a Linux operating system or other type of operating system.

The cloud infrastructure 400 further comprises sets of applications 410-1, 410-2, . . . 410-L running on respective ones of the VMs/container sets 402-1, 402-2, . . . 402-L under the control of the virtualization infrastructure 404. The VMs/container sets 402 may comprise respective VMs, respective sets of one or more containers, or respective sets of one or more containers running in VMs.

In some implementations of the FIG. 4 embodiment, the VMs/container sets 402 comprise respective VMs implemented using virtualization infrastructure 404 that comprises at least one hypervisor. A hypervisor platform may be used to implement a hypervisor within the virtualization infrastructure 404, where the hypervisor platform has an associated virtual infrastructure management system. The underlying physical machines may comprise one or more distributed processing platforms that include one or more storage systems.

In other implementations of the FIG. 4 embodiment, the VMs/container sets 402 comprise respective containers implemented using virtualization infrastructure 404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 400 shown in FIG. 4 may represent at least a portion of one processing platform. Another example of such a processing platform is processing platform 500 shown in FIG. 5.

The processing platform 500 in this embodiment comprises a portion of system 100 and includes a plurality of processing devices, denoted 502-1, 502-2, 502-3, . . . 502-K, which communicate with one another over a network 504.

The network 504 may comprise any type of network, including by way of example a global computer network such as the Internet, a wide area network (WAN), a local area network (LAN), a satellite network, a telephone or cable network, a cellular network, a wireless network such as a WiFi or WiMAX network, or various portions or combinations of these and other types of networks.

The processing device 502-1 in the processing platform 500 comprises a processor 510 coupled to a memory 512.

The processor 510 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 512 may comprise random access memory (RAM), read-only memory (ROM), flash memory or other types of memory, in any combination. The memory 512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 502-1 is network interface circuitry 514, which is used to interface the processing device with the network 504 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for managing digital certificates in endpoint devices as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, time sources, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured to perform steps of:
receiving a hash value for a digital certificate and an amendment for a portion of the digital certificate;
determining whether the hash value corresponds to a last version of the digital certificate on the at least one processing device; and
incorporating the amendment into a new version of the digital certificate in response to determining that the hash value corresponds to the last version of the digital certificate on the at least one processing device.

2. The apparatus of claim 1 wherein the at least one processing device is further configured to perform steps of:
determining that the hash value fails to correspond to the last version of the digital certificate on the at least one processing device;
generating a notification for a source of the amendment that the hash value fails to correspond to the last version of the digital certificate; and
maintaining the last version of the digital certificate without incorporating the amendment.

3. The apparatus of claim 1 wherein the amendment comprises a restatement associated with the portion of the digital certificate.

4. The apparatus of claim 3 wherein the restatement comprises one of a full restatement and a partial restatement.

5. The apparatus of claim 3 wherein the restatement comprises a revocation of the portion of the digital certificate.

6. The apparatus of claim 1 wherein the amendment specifies an identifier for the digital certificate and one or more changes to the portion of the digital certificate.

7. The apparatus of claim 1 wherein the at least one processing device is further configured to perform the step of applying one or more rules designed to ensure application of any amendments to the last version of the digital certificate that have been issued, wherein the one or more rules specify a maximum time interval within which to perform a check to determine whether any amendments to the last version of the digital certificate have been issued.

8. The apparatus of claim 7 wherein:
the one or more rules further specify one or more operations to be performed by the at least one processing device in response to a failure to perform the check within the maximum time interval; and
the at least one processing device is further configured to perform the step of executing the one or more operations in response to the failure to perform the check within the maximum time interval.

9. The apparatus of claim 8 wherein the one or more operations comprise at least one of generating a warning message indicating the failure to perform the check within the maximum time interval, preventing future operations authorized by the last version of the digital certificate following expiration of the maximum time interval, and terminating existing operations authorized by the last version of the digital certificate following expiration of the maximum time interval.

10. The apparatus of claim 1 wherein, in incorporating the amendment into the new version of the digital certificate, the at least one processing device is configured to perform the step of replacing the last version of the digital certificate with the new version of the digital certificate.

11. The apparatus of claim 10 wherein the incorporating and the replacing are performed by the at least one processing device in the same operation.

12. The apparatus of claim 1 wherein the at least one processing device comprises an endpoint device and the amendment is issued by a certificate authority.

13. A computer program product comprising a non-transitory processor-readable storage medium having stored therein program code of one or more software programs, wherein the program code when executed by at least one processing device causes the at least one processing device to perform steps of:
receiving a hash value for a digital certificate and an amendment for a portion of the digital certificate;
determining whether the hash value corresponds to a last version of the digital certificate on the at least one processing device; and
incorporating the amendment into a new version of the digital certificate in response to determining that the hash value corresponds to the last version of the digital certificate on the at least one processing device.

14. The computer program product of claim 13 wherein the program code further causes the at least one processing device to perform steps of:
determining that the hash value fails to correspond to the last version of the digital certificate on the at least one processing device;
generating a notification for a source of the amendment that the hash value fails to correspond to the last version of the digital certificate; and
maintaining the last version of the digital certificate without incorporating the amendment.

15. The computer program product of claim 13 wherein the program code further causes the at least one processing device to perform the step of applying one or more rules designed to ensure application of any amendments to the last version of the digital certificate that have been issued, wherein the one or more rules specify a maximum time interval within which to perform a check to determine whether any amendments to the last version of the digital certificate have been issued.

16. The computer program product of claim 15 wherein:
the one or more rules further specify one or more operations to be performed by the at least one processing device in response to a failure to perform the check within the maximum time interval; and
the program code further causes the at least one processing device to perform the step of executing the one or more operations in response to the failure to perform the check within the maximum time interval.

17. A method comprising:
receiving a hash value for a digital certificate and an amendment for a portion of the digital certificate;
determining whether the hash value corresponds to a last version of the digital certificate on at least one processing device; and
incorporating the amendment into a new version of the digital certificate in response to determining that the hash value corresponds to the last version of the digital certificate on the at least one processing device;
wherein the method is performed by the at least one processing device and the at least one processing device comprises a processor coupled to a memory.

18. The method of claim 17 further comprising:
determining that the hash value fails to correspond to the last version of the digital certificate on the at least one processing device;
generating a notification for a source of the amendment that the hash value fails to correspond to the last version of the digital certificate; and
maintaining the last version of the digital certificate without incorporating the amendment.

19. The method of claim 17 further comprising applying one or more rules designed to ensure application of any amendments to the last version of the digital certificate that have been issued, wherein the one or more rules specify a maximum time interval within which to perform a check to determine whether any amendments to the last version of the digital certificate have been issued.

20. The method of claim 19 wherein:
the one or more rules further specify one or more operations to be performed by the at least one processing device in response to a failure to perform the check within the maximum time interval; and
the method further comprises executing the one or more operations in response to the failure to perform the check within the maximum time interval.
